(19) United States
(12) Patent Application Publication
(10) Pub. No.: US 2026/0359168 A1
(43) Pub. Date: Nov. 12, 2026

(54) Method and Device for Detecting Hardware Register Errors

(71) Applicant: Sandisk Technologies, Inc., Milpitas, CA (US)

(72) Inventors: Boris Yarovoy, Maalot-Tarshiha (IL); Felix Laevsky, Kiryat Ata (IL); Asaf Gueta, Ganei Tikva (IL)

(73) Assignee: Sandisk Technologies, Inc., Milpitas, CA (US)

(21) Appl. No.: 19/204,619

(22) Filed: May 12, 2025

(51) Int. Cl. G06F 11/10

(52) U.S. Cl. CPC G06F 11/1076

(57) ABSTRACT

A data storage device includes a non-volatile memory that stores data and a volatile memory including one or more hardware registers, including a first register configured to store one or more bits including a first bit having a first value. A data path provides data communication between a host device and the non-volatile memory. The hardware registers may store an access parameter defining access by the host device to the data stored in the non-volatile memory. Error protection circuitry detects and corrects bit flips in the first register. A controller enables write protection for the first register and, when write protection is enabled, and a bit-flip is detected of the first bit of the first register from the first value to a second value, causes, by the error protection circuitry, the first bit of the first register to change from the second value back to the first value.

### TECHNICAL FIELD

Aspects of the disclosure relate generally to devices and methods for detecting a bit-flip in a hardware register of a digital device and, more specifically, to devices and methods for correcting undesirable bit-flips in a hardware register.

### BACKGROUND

Digital devices are often configured to store operational data that defines the function of the digital device. The operational data stored by a digital device may comprise: executable instructions; configuration parameters; control information; security parameters; security data (such as encryption keys); current state information; or operational logs. The operational data may be configured to define the intended functionality of the device.

In some devices, the operational data may be intentionally altered, for example by a user, to alter the functionality of the device. However, unintentional alteration of one or more bits of the operational data may have undesirable and unpredictable consequences. These consequences may cause the device to fail to operate as intended by the user. Furthermore, these undesirable and unpredictable consequences may pose security and safety risks to the device, or to users of the device.

Accordingly, there is a desire to provide a device and method that ameliorates one or more of these difficulties, or other difficulties, or at least provide a useful alternative.

Any discussion of documents, acts, materials, devices, articles or the like that has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

In accordance with an aspect of the present disclosure, there is provided a device comprising a volatile memory comprising a set of one or more hardware registers, the set of one or more hardware registers comprising a first register configured to store one or more bits including a first bit having a first value. The device further comprises error protection circuitry configured to detect and correct at least one bit-flip in the first register, and a controller. The controller is configured to enable write protection for the first register. The controller is further configured to, responsive to write protection being enabled for the first register, and responsive to detecting, by the error protection circuitry, the occurrence of a bit-flip of the first bit of the first register from the first value to a second value, cause, by the error protection circuitry, the first bit of the first register to change from the second value to the first value.

In some embodiments, the first register comprises a plurality of bits, each bit comprising a respective first value. In some embodiments, the error protection circuitry comprises a store of one or more error protection bits associated with the register, each error protection bit comprising a value calculated from the first value of each of the one or more bits of the first register.

In some embodiments, the controller is further configured to, for each error protection bit of the one or more error protection bits, determine the value of the error protection bit to satisfy a parity function.

In some embodiments, the respective values of the error protection bits are determined in accordance with one or more of: a Hamming code; a Single-bit Error Correction, Double-bit Error Detection (SECDED) code; Reed Solomon code; a Bose-Chaudhuri-Hocquenghem (BCH) code; and a Low-Density Parity-Check (LDPC) code.

In some embodiments, the controller is further configured to, responsive to detecting, by the error protection circuitry, the occurrence of a bit-flip of a first bit of the error protection bits from a first value of the error protection bit to a second value of the error correction bit, cause, by the error protection circuitry, the first bit of the error protection bits to change from the second error protection bit value to the first error protection bit value.

In some embodiments, the controller is further configured to, responsive to write protection being enabled for the first register, apply, by the error protection circuitry, an error protection algorithm to the first register.

In some embodiments, the error protection algorithm comprises one or more of: a Hamming code; a Single-bit Error Correction, Double-bit Error Detection (SECDED) code; Reed Solomon code; a Bose-Chaudhuri-Hocquenghem (BCH) code; and a Low-Density Parity-Check (LDPC) code.

In some embodiments, applying the error protection algorithm comprises, in response to a trigger event, applying the error protection algorithm to the one or more bits of the first register, and the one or more error protection bits. In some embodiments, the trigger event comprises one or more of: a clock edge; a read of the first register; a set period of time; a set number of clock cycles; and an error check signal.

In some embodiments, the controller is configured to enable write protection of the first register in response to receiving, from a controlling entity, an instruction to enable write protection of the register. In some embodiments, enabling write protection for the first register comprises receiving, from a controlling entity, a write command to a write protection control register, the write command comprising a write protection control value, and determining, based on the write protection control value, a subset of one or more registers of the set of one or more hardware registers, wherein the subset of one or more registers comprises the first register.

In some embodiments, determining, based on the write protection control value, a subset of one or more registers of the set of one or more hardware registers comprises applying an operation to the write protection control value. In some embodiments, the operation comprises one or more of: an arithmetic operation; a binary operation; a numerical operation; a logical shift operation; and an arithmetic shift operation.

In some embodiments, enabling write protection for the first register comprises receiving, from a controlling entity, a write command to a write protection activation register.

In some embodiments, the controller is further configured to, responsive to write protection being enabled for the register, and responsive to receiving a write command for the first register, issue a write error signal. In some embodiments, the controller is further configured to, receive the write command, via a data interface, from a host computer, and transmit the write error signal, via the data interface, to the host computer.

In some embodiments, the controller is further configured to, responsive to write protection being disabled for the register, and responsive to receiving a write command for the first register, the write command comprising a write value, change the value of the bits of the first register to the write value. In some embodiments, the controller is further configured to, in response to detecting, by the error protection circuitry, the occurrence of a bit-flip of the bit of the register from the first value to a second value, issue an error signal.

In some embodiments, the device further comprises a non-volatile memory configured to store data, and a data path configured to provide data communication between a host computer system and at least part of the non-volatile memory, wherein at least one of the one or more hardware registers is configured to store an access parameter defining access by the host computer to the data configured to be stored in the non-volatile memory.

In accordance with another aspect of the present disclosure, there is provided a method performed by a controller of a data storage device. The data storage device comprises a non-volatile memory configured to store data, and a data path configured to provide data communication between a host computer system and at least part of the non-volatile memory of the data storage device. The data storage device further comprises volatile memory comprising a set of one or more hardware registers, the set of one or more hardware registers comprising a first register configured to store one or more bits including a first bit having a first value, error protection circuitry configured to detect and correct at least one bit-flip in the first register, and the controller. The method comprises enabling write protection for the first register, and, responsive to write protection being enabled for the first register, and responsive to detecting, by the error protection circuitry, the occurrence of a bit-flip of the first bit of the first register from the first value to a second value, causing, by the error protection circuitry, the first bit of the first register to change from the second value to the first value.

In accordance with another aspect of the present disclosure, there is provided a data storage device comprising a non-volatile memory configured to store data, and a data path configured to provide data communication between a host computer system and at least part of the non-volatile memory. The data storage device further comprises volatile memory comprising a set of one or more hardware registers, the set of one or more hardware registers comprising a first register configured to store one or more bits including a first bit having a first value. The data storage device further comprises means for enabling write protection for the first register, and means for, responsive to write protection being enabled for the first register, and responsive to detecting the occurrence of a bit-flip of the first bit of the first register from a first value to a second value, causing the first bit of the first register to change from the second value to the first value.

### BRIEF DESCRIPTION OF DRAWINGS

The embodiments of the disclosure will now be described with reference to the accompanying drawings, in which:

FIG. 1 illustrates a data storage device (DSD) and a host computer system, in accordance with an embodiment;

FIG. 2 illustrates a portion of the register manager, in accordance with an embodiment;

FIG. 3 illustrates a state diagram of the access state of a register of the device, in accordance with an embodiment;

FIG. 4 illustrates a message sequence to set and clear write protection of a register of the device, in accordance with an embodiment;

FIG. 5 illustrates the determination of EP bits for a register in accordance with a Hamming code, in accordance with an embodiment; and

FIG. 6 illustrates the detection of a bit-flip in the register of FIG. 5 in accordance with a Hamming code, in accordance with an embodiment.

### DESCRIPTION OF EMBODIMENTS

The operation of a digital device is often defined, at least in part, by the operational data retained by the device. Operational data may comprise: executable instructions; configuration parameters; operating parameters; control information; security parameters; security data (such as encryption keys); current state information; or operational logs.

As the unintentional (including malicious) alteration of the operational data can have adverse impacts on the operation of a device, it is desirable to provide some resilience against the threat of unintentional alteration of the operational data. Write access control (e.g., write protection) may be utilised to prevent unintentional overwriting of operational data, by an entity that has access to the stored operational data. However, unintentional alteration of operational data may also occur in response to external factors. One of the ways in which operational data may be unintentionally altered is through a phenomenon known as a bit-flip.

Described herein is a methods and devices that exhibit resilience against bit-flips. In particular, embodiments described herein leverage error detection and correction techniques to protect write protected data that is stored in hardware registers in the device. Notably, methods described herein provide error protection from bit-flips for data stored in hardware flip-flops.

Advantageously, embodiments described herein provide for the controller to automatically apply error protection on each write protected register. Accordingly, a controlling entity, such as the host computer or firmware executing on the controller, can mitigate the effects of bit-flips by configuring a register to be write-only.

Advantageously, the methods provided herein provide for a controlling entity (e.g., a host computer, the controller of the device, or firmware/software executing on the device) to configure a hardware register with desired operational data and lock the register (e.g., enabling write protection) to prevent unintentional write operations.

Methods described herein provide for a tailorable approach to the application of error protection, such that a controlling entity is provided the control to select registers for error protection. Accordingly, instead of applying error protection across all hardware registers indescriminantly, which may be resource intensive (e.g., in terms of power, circuitry and clock cycles), the controlling entity, which has knowledge of which operational data is critical to the safe and secure operation of the device, can select to apply write protection on registers that are storing key operational data. Thus, a controlling entity can enable protection from bit-flips for key operational data by enabling write protection for the register storing the operational data. An advantage of the described embodiments is improved mitigation of the effect of bit-flips.

### Operational Data for Data Storage Devices

In some embodiments in which the device comprises a data storage device, the hardware registers 112 are configured to store operational data which defines how the host computer, acting as a controlling entity, may utilise the storage medium 108 to store and retrieve user data. For example, the operational data may define one or more regions of the storage medium, which may be used by the host computer to stored and retrieve user data. In some embodiments, the operational data comprises authentication parameters, which may be used to authenticate the host computer's (or a user thereof) access to the storage medium. In some embodiments, the operational parameters define data security protocols to apply to the user data stored in, and read from, the storage medium. The operation parameters may comprise encryption/decryption parameters. In some embodiments, the operational parameters comprise data transfer parameters, which define how blocks of user data are to be transferred between the host computer and the storage medium.

Advantageously, ameliorating the effects of bit-flips on the operational data which defines how the host computer may utilise the storage medium 108 of the data storage device to store and retrieve user data provides a more reliable data storage service to the host computer.

### Bit Flips

In digital technology, a bit-flip refers to the unintentional or malicious switching of a bit's value from a ‘0’ to a ‘1’, or vice versa. Bit flips may be caused by faulty or poorly designed equipment. In some cases, bit-flips may be caused by unavoidable natural phenomena, such as a high-energy charged particle striking the hardware storing a bit, causing the bit to flip. The particle may comprise cosmic radiation, originating from space. A bit-flip may also be caused by radiation in the environment around the device, heat, or electromagnetic interference. In some situations, bit-flips may also be caused by maliciously applied radiation, intending to disrupt the normal operation of the device.

A bit-flip to user data stored on a device may result in damaged, corrupted or unreadable user data. A bit-flip to operational data on a device can cause single event upsets (also known as a single event error), in which the change to operational data stored by the device can cause the device to malfunction. Single event upsets are a form of soft error, which may need to be addressed by resetting the device back to a reset state, or a known previous state.

A digital device may be configured to store the operational data in volatile memory, non-volatile memory, or a combination thereof. A digital device can store data in volatile or non-volatile memory types. Volatile memory types include, but not limited to: Random Access Memory (RAM); Static Random Access Memory (SRAM); registers; and caches. Non-volatile memory types include, but are not limited to: Read Only Memory (ROM); Electronically Erasable Programmable Read-Only memory (EEPROM) and flash memory. A device, comprising a data storage device, may also be configured to store user data, in addition to operational data.

A bit-flip can occur to data stored in volatile or non-volatile memory types. Typically, for a data storage device, the user data is stored in non-volatile memory. In many digital devices, at least some of the operational data is stored in volatile memory, such as a hardware register comprised of flip-flops.

The type of malfunction exhibited by the device may depend on the intended functionality of the device and the nature of the operational data that experienced the bit-flip. For example, a bit-flip in a register configured to store Global Positioning System coordinates may result in a navigation error. In another example, a bit-flip in a register configured to store a cryptographic key may result in the inability to decrypt incoming transmissions. Accordingly, for security and/or safety reasons, it is often desirable to ameliorate the risks associated with bit-flips.

### Error Detection and Correction

A device may utilise error protection techniques, comprising error detection or error detection and correction, to ameliorate the security and safety risks associated with bit-flips on data retained by a digital device. Error detection techniques are configured to identify the occurrence of a bit-flip. In some cases, error protection techniques are configured to identify the specific bit (or bits) that experienced a bit-flip.

Error detection techniques may be used in conjunction with error correction techniques. Error correction techniques are configured to correct the bit-flip, by reverting the flipped bit back to its intended value.

### Data Storage Devices

The technology described herein may be embodied by a variety of different devices, including but not limited to: a data storage device, configured to store user data; a device that does not provide data storage for user data; a device configured to communicate with another device over wired or wireless communication channels; a stand-alone device that is not configured to communicate with another device; a device comprising non-volatile memory; a device comprising only volatile memory; a slave device; a master device; a device comprising at least one processor; a device comprising application-specific integrated circuits; or any combination thereof.

Data storage devices (DSDs) are electronic devices with the capability to store information in the form of digital data. DSDs are typically deployed as an integrated part of, or as a removable component configured to interface with, a computing system for the purpose of improving the data transmission and storage capabilities of the system. From the perspective of the computing system, a DSD is typically implemented as a block storage device where the data stored is in the form of one or more blocks, being sequences of bytes or bits having a maximum length, referred to as block size.

DSDs are commonly used to supplement the data storage capabilities of a computer system. For example, external DSDs are often standalone physical devices which house an internal storage component, such as a hard disk drive (HDD) or a solid state drive (SSD), that provides a host computing system with an additional portion of non-volatile memory (i.e., the volume of the drive) in which to store digital data. These external drive type devices are connectable to the host computer system by way of a data path operating over a particular connectivity protocol (e.g., via Universal Serial Bus (USB) cable). In response to being connected to the host computer system, the host computer system recognizes the drive as a block data storage device such that a user of the device may access the storage of the drive by way of the data path (e.g., through operation of the host computer). Access to the drive typically enables a user to access (e.g., read, write and/or modify) user data content stored on the drive.

The functionality provided by a DSD to an end user is often determined by system one or more programs or routines executed by the DSD (referred to as “control software” herein). The control software may include a set of system-level applications and programs (such as an embedded operating system and/or firmware) and related data that enable the DSD to perform one or more intended functions on user data (e.g., to receive, protect, modify, store and retrieve the user data).

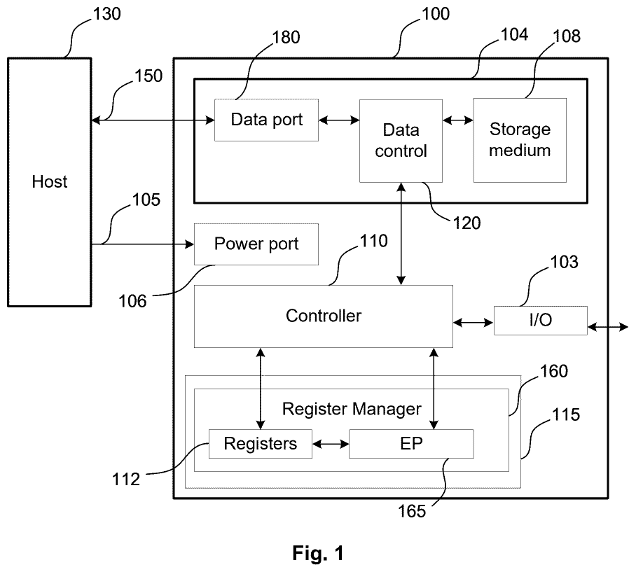

### FIG. 1—Data Storage Device

FIG. 1 illustrates a data storage device (DSD) 100 (hereinafter ‘device 100’) and a host computer system 130, in accordance with an embodiment. The device 100 is configured to provide data storage functionality to the host computer system 130 (hereinafter ‘the host 130’). The device 100 comprises a data path 104 and a controller 110. The data path 104 comprises a data port 180 configured to receive data from the host computer system 130 and configured to transmit data from the device 100 to the host 130.

### Storage Medium

The data path 104 further comprises a storage medium 108 to provide non-volatile data storage functionality to the host 130. The storage medium 108 may also store data to be utilised by the device 100. The data stored in storage medium may include one or more blocks of data organized into files, for example including images, documents, videos, etc., according to a particular file system operable by the host 130. The storage medium 108 is non-transitory so as to retain the stored data irrespective of whether the storage medium is powered.

The storage medium 108 may comprise flash memory, which may be in the form of secure digital (SD) memory or iNAND® embedded flash memory. The storage medium may comprise a hard disk drive (HDD) with a rotating magnetic disk or a solid state drive (SSD) and its variations like SLC (Single Level Cell), eMLC (Enterprise Multi Level Cell), MLC (Multi Level Cell), TLC (Triple Level Cell), and QLC (Quadruple Level Cell), and combinations of the above such as SSHD. Any other type of non-volatile storage media may also be used, including emerging non-volatile memory such as Program in Place or Storage Class Memory (SCM), such as ReRam, PCM, and MRAM. Further, the storage medium may be a block data storage device, such that the data is written in blocks to the storage medium and read in blocks from the storage medium.

### Interfaces

The device 100 may be communicatively connected to the host 130 via a data interface 150. The data interface is configured to transmit data to and from the data port 180 and the host 130. The data interface 150 may comprise a wired interface, a wireless interface, a packet switched network, a memory buffer, a memory space that is accessible by the host and the device, any combination of these means, or another means of conveying data between the host and the device. Data transmitted over the data interface 150 may comprise commands, command responses, status information, data, user data or other digital information. The host 130 may comprises a device driver which is configured to communicate with the device 100 over data interface 150.

The host 130 may further be configured to provide power to the device 100 over power interface 105 to power port 106. The power port and the data port may be implemented collectively as, for example, some form of USB port (e.g., USB-A, USB-8, USB-C, mini-USB, micro-USB, etc.), a Thunderbolt port, a Power over Ethernet (PoE) port, or a similar port. The device 100 may receive power from a source other than the host 130.

In one embodiment, the power interface 105 comprises a USB interface which is configured to supply typically 5 V at 500 mA or higher currents. In one embodiment, the power interface 105 comprises a wireless charging interface. In one embodiment, in response to the device 100 being operably coupled to host 130 via interface 105, the device 100 consumes power from the host 130 to operate the electronic circuitry of the device 100.

### IO Interface

The device 100 may include an input/output (IO) interface 103. The IO interface 103 may include one or more input components configured to accept an input from a user. For example, the input components may include a set of buttons or a keypad, or a similar arrangement of mechanical components that collectively enable the selection of digits or characters for entering into the device 100. The input components may also include one or more communications devices, such as a wireless modem, configured to receive and transmit data wirelessly via the transmission of an electronic message in a predetermined form.

The IO interface 103 may include one or more output components configured to indicate information to a user. For example, the output components may include a speaker, configured to emit audible signals, one or more visual indicators, such as a light or a display, configured to emit visual signals.

### Data Control

The device 100 further comprises a data control unit 120 configured to manage data stored in the non-volatile storage medium. The data control unit 120 is configured to perform read operations to read data from the storage medium 108 and provide data to the host 130 via the data port 180, or to the controller 110 for use by the controller 110. The data control unit 120 is further configured to perform write operations to write data, received from the host 130 via the data port 180, to the storage medium 108. The data control unit 120 may further write data, received from the controller 110, to the storage medium 108. In some embodiments, the data control unit 120 may process the data before writing data to the storage medium.

In some embodiments, the data control unit 120 includes a cryptography engine configured to receive, interpret and execute commands received from host 130 according to a predetermined command set, such as for example the standard Advanced Technology Attachment (ATA) or serial ATA (SATA) and/or ATA Packet Interface (ATAPI) command set, which is available from Technical Committee T13 noting that identical functionalities can be implemented within Trusted Computing Group (TCG) Opal, Small Computer System Interface (SCSI) and other proprietary architectures.

The cryptography engine may be connected between the data port 180 and the storage medium 108 and be configured to use a cryptographic key to encrypt data to be stored on the storage medium 108, and to decrypt the encrypted data stored on the storage medium 108 in response to a request from the host 130. The controller 110 causes the cryptography engine 107 to control a cryptographic state of the data stored in the storage medium 108 (i.e., encrypted or plain). In one mode of operation, the unencrypted data may pass through the data path 104 to the host 130 via the data port 180.

### Controller

The device 100 further comprises a controller 110. The controller 110 may comprise one or more processors, configured to, individually or in combination, perform functions as described herein. The at least one processor may include one or more of an integrated electronic circuit, a microprocessor, a microcontroller or controlling circuitry. The controller 110 is configured to execute program code stored within the system memory 115 to issue commands for controlling the operation of the device 100. Accordingly, actions performed by the device 100 may be considered to be actions performed by the controller 110. Similarly, decisions and determinations made by the device 100 may be considered to be decisions and determinations made by the controller 110. In some embodiments, the controller 110 comprises a controlling entity, controlling the function of the device. In other embodiments, or at other times, the controller may act on instructions from another controlling entity, such as a entity operating on the host computer 130.

The system memory 115 may further store operational data which defines the function of the device 100. The device 100 may receive operational data from the host 130, and store the operational data in the system memory 115. The system memory may comprise volatile memory, non-volatile memory, or a combination thereof.

The function of the controller 110 includes, but is not limited to, controlling data transmission through data path 104, and responding to commands receive from the host 130, as described herein.

### Registers

The device 100 further comprises a register manager 160, configured to manage a set of hardware registers 112. The hardware registers are configured to store operational data to be used by the controller 110 during operation of the device 100.

A hardware register is part of the digital circuitry of the device. Each register of the set of registers is comprised of one or more flip-flops, wherein each flip-flop is configured to store a single bit. In this embodiment, each register comprises 8 flip-flops, configured, collectively to store 8-bits. It is to be understood that in other embodiments, a register may comprise more or fewer flip-flops.

The registers provide the controller with a fast memory location within the device to store operational data. A register may be used to store configuration data or instructions to be used by firmware executing on a processor of the controller, or circuity of the controller. In some embodiments, the registers may be accessible, or partially accessible, to the host computer, such that the host computer can read from, or write to, to hardware registers 112 of the device.

### Error Detection and Correction

The register manager 160 comprises an error protection (EP) module 165 configured to perform an error protection algorithm. The EP module is configured to ameliorate the consequences of a bit-flip occurring in a flip-flop of a register in the set of registers 112. The EP module is configured to perform error detection, in which the EP module detects the occurrence of a bit-flip in the registers. In some embodiments, including the embodiment illustrated in FIG. 1, the EP module is also configured to perform error correction, in which the EP module is configured to, responsive to the occurrence of the bit-flip, correct the bit-flip by reverting the flipped bit back to its original value.

In some embodiments, the EP module is configured to perform error detection, but is not configured to perform error correction. In some embodiments, the EP module is configured to issue an error signal to the controller, responsive to the occurrence of a bit-flip. In some embodiments, the EP module is configured record an event log, responsive to the occurrence of a bit-flip.

In some embodiments, it may be desirable for a controlling entity to selectively apply error protection to only a subset of the hardware registers, or for only a period of time. The controlling entity may select to apply error protection based on the nature of the data stored by the register. For example, operational data that is critical to the safe and secure operation of the device may be protected from bit-flips. Error protection may be applied to only a subset of the hardware registers of the device 100. Alternatively, or additionally, error protection may be applied to a hardware register selectively, wherein the controlling entity is configured to selectively enable and disable error protection for a register.

A controlling entity may apply error protection to registers that are configured to store important operational data that is utilised for the safe and secure operation of the device. Conversely, the controlling entity may elect to not apply error protection to registers that are not utilised, or not currently utilised, for storing critical operational data.

The EP module may be configured to apply error protection to a subset of the hardware registers. The hardware registers to which the EP module is configured to apply error protection are referred to as protected registers.

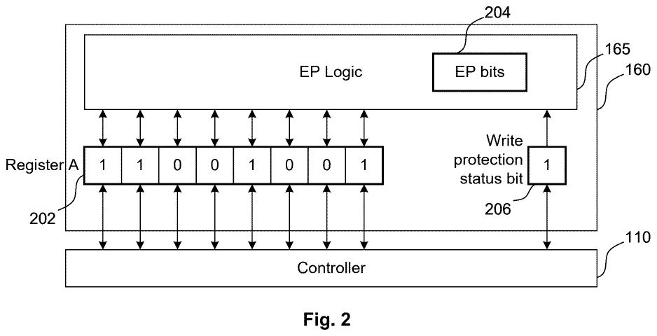

### FIG. 2—Register Circuitry

FIG. 2 illustrates a portion of the register manager 160, in accordance with an embodiment. In particular, FIG. 2 illustrates an 8-bit register (Register A) 202, of the set of registers 112. Each bit of the register 202 is electronically connected to the EP module 165, such that the EP module can determine the value of each bit of the register. Similarly, each bit of the register 202 is electronically connected to the controller 110, such that the controller can perform read operations and write operations on the register 202. The EP module comprises one or more EP bits 204 associated with the register 202. The EP bits are used by the EP module to detect the occurrence of a bit-flip, and, if the EP module is configured to perform error correction, correct the bit-flip.

For each register of the set of registers 112, the register manager 160 comprises an indication of the write protection status of the register. In the example shown in FIG. 2, the write protection status of register 202 is maintained as write protection status bit 206. The write protection status bit may be set and cleared by the controller 110. The write protection status bit may be read by the EP module to determine whether register 202 is a protected register.

In response to the write protection status bit 206 for register 202 being set, the EP module is configured to perform error protection for register 202. The EP module continuously performs error protection for register 202, while the write protection status bit 206 is set.

In some embodiments, a write protection status bit may be configured to indicate the write protection status of a plurality of registers. In such a case, responsive to the write protection status bit being set, the EP module is configured to perform error protection for each of the plurality of registers represented by the write protection bit.

### Setting Write Protection

A register may be write protected to prevent the value stored by the register being altered. In some embodiments, the controller 110 of the device is configured to set (e.g., enable) write protection for a register. In some embodiments, the controller is configured to set write protection for a register in response to the current state of the device. For example, in response to the completion of an initialisation state of the device, in which the register is set to a desired initialisation value, the controller may set write protection for the register to prevent alteration of the desired value of the register.

In some embodiments, the controller is configured to set write protection for the register in response to receiving a command from the host computer via the data connection 150.

One or more registers of the set of registers 112 may be configured to be write protected. The register manager comprises a write protection status bit 206 for each register that may be write protected. The controller is configured to set write protection for register 202 by setting the write protection status bit 206 to ‘1’.

Responsive to receiving a command from the host computer to write to a register for which write protection has been set, the controller is configured to not perform the write command. In some embodiments, the controller may be configured to issue an error message to the write protection, wherein the error message indicates that the write command was not performed.

The controller may clear (e.g., disable) write protection so that the value stored in the register may be altered. In accordance with the embodiment illustrated in FIG. 2, the controller is configured to set write protection for register 202 by setting the write protection status bit 206 to ‘0’.

### Write Protection Configuration Register

In some embodiments, the set of registers comprises a write protection activation register (WPAR), and the controller is configured to, in response to a write protection activation value (WPAV) being written to the WPAR, enable write protection for one or more registers.

Advantageously, a malicious party, seeking to tamper with the write protection status of the hardware registers may have knowledge of the address of the write protection control register; however, without knowledge of the WPAV, the malicious party is unable to set write protection for the hardware registers.

In some embodiments, the set of registers comprises a write protection configuration register (WPCR), and the controller is configured to, in response to a write protection configuration value (WPCV) being written to the WPCR, enable write protection for one or more registers as indicated by the WPCV.

The register manager is configured to determine, based on the WPCV, which one or more hardware registers to set write protection on. For example, in some embodiments, each bit of the WPCV may correspond to a specific hardware register. In response to a bit of the WPCV being set, the register manager sets write protection for the corresponding hardware register.

In another example, the register manager is configured to apply a function to the WPCV to determine which hardware registers are to be write protected. The function may include, but is not limited to, one or more of: applying an arithmetic operation to the WPCV; applying a binary operation to the WPCV; applying a numerical operation to the WPCV; applying a logical shift to the WPCV; and applying an arithmetic shift to the WPCV.

Advantageously, the application of a function to the WPCV provides a layer of obfuscation to the configuration of write protection for the hardware registers. Accordingly, a malicious party, seeking to tamper with the write protection status of the hardware registers may have knowledge of the address of the write protection control register; however, without knowledge of the function to be applied to the WPCV, it may be infeasible for the malicious party to tamper with the write protection status of the hardware registers.

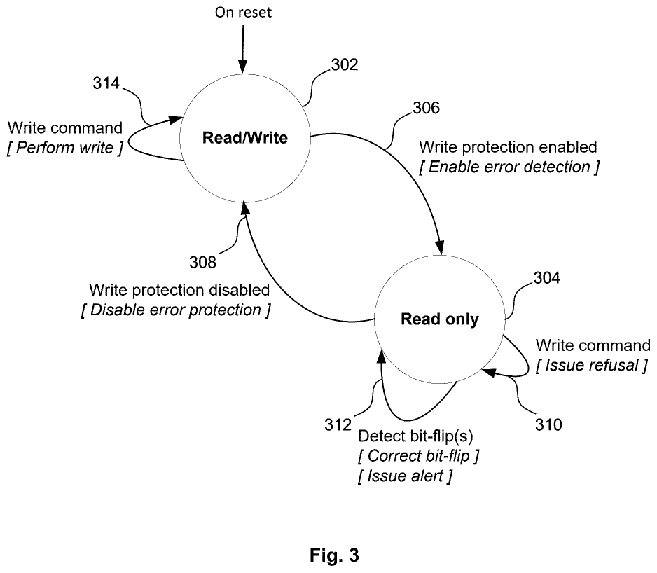

### FIG. 3—State Diagram

FIG. 3 illustrates a state diagram 300 of the access state of a register of the device, in accordance with an embodiment. The register manager 160 is configured to maintain an access state for each protected register of the set of registers 112. The register manager is configured to maintain the access status for each protected register in accordance with the state diagram 300.

A register may be in a read/write access state 302, in which the controller is configured to perform read operations and/or write operations 314 on the register. Alternatively, a register may be in a read only state 304, in which the controller is configured to perform read operations on the register, but the controller is not permitted to write to the register.

The register manager 160 is configured to, responsive to write protection being enabled for a protected register, transition 306 the state of the protected register from the read/write state 302 to the read only state 304. In some embodiments, write protection may be enabled for a register by the controller setting a write protection status bit associated with the register.

In the read only state 304, in response to the register manager receiving a write command to the register, the register manager will not write to the register. In some embodiments, the register manager will issue an error signal 310 to the controller to indicate that the write command was refused.

Additionally, responsive to write protection being enabled for a protected register, the controller is configured to enable error protection for that register. Enabling error protection for a register comprises determining the value of the EP bits associated with that register. In response to determining the occurrence of a bit-flip 310 in the register, the EP module may be configured to correct the bit-flip. The EP module may be configured to issue an alert to the controller in response to detecting the bit-flip. The controller may be configured to record an error log entry in system memory 115 in response to detecting the bit-flip.

The register manager 160 is configured to, responsive to write protection being disabled for a protected register, transition 308 the state of the protected register from the read only state 304 to the read/write state 302. In some embodiments, write protection may be disabled for a register by the controller clearing a write protection status bit associated with the register.

In some embodiments, the register manager is configured to set the access status of a register to the read/write state 302 on reset of the device 100. In some embodiments, the register manager is configured to set the access status of a register to the read only state 304 on reset of the device 100.

### Protection Configuration

In some embodiment, the register manager is configured to retain configuration information which defines which registers write protection is to be applied to, and how write protection is to be applied to the registers

The configuration information may indicate which one or more registers of the set of registers 112 is a protected register. A protected register is a register to which write protection may be applied. The register manager may be configured to apply write protection for a register in response to receiving a write protection signal from the controller. In some embodiments, one or more of the registers may be write protected upon reset of the device. In some embodiments, one or more of the registers may be permanently write protected. That is, write protection cannot be disabled for such registers.

In some embodiments, the configuration information comprises information regarding the configuration of error protection. For example, the configuration information may indicate one or more of: the extent of error protection (e.g., error detection, or error detection and correction) to be applied to a register; the type of error protection to be applied to a register (e.g., which specific error protection algorithm); a trigger event for the EP module to apply an error protection algorithm to the register. The trigger event may comprises one or more of: a clock edge; a read of the first register; a set period of time; a set number of clock cycles; and an error check signal.

### Error Protection Repetition

For each register for which error protection is set, The EP module is configured to perform error protection to check whether a bit-flip has occurred. The EP module may be configured to perform error protection periodically. The EP module may be configured to perform error protection continuously, on each clock cycle of the device, while the error protection is set.

The EP module may be configured to perform error protection for a register in anticipation of the register being read. The EP module may be configured to perform error protection for a register responsive to a signal from the controller 110. For example, the controller may signal to the EP module that the controller intends to read the value of Register A, and the EP module may be configured to, responsive to this signal, perform error protection for Register A.

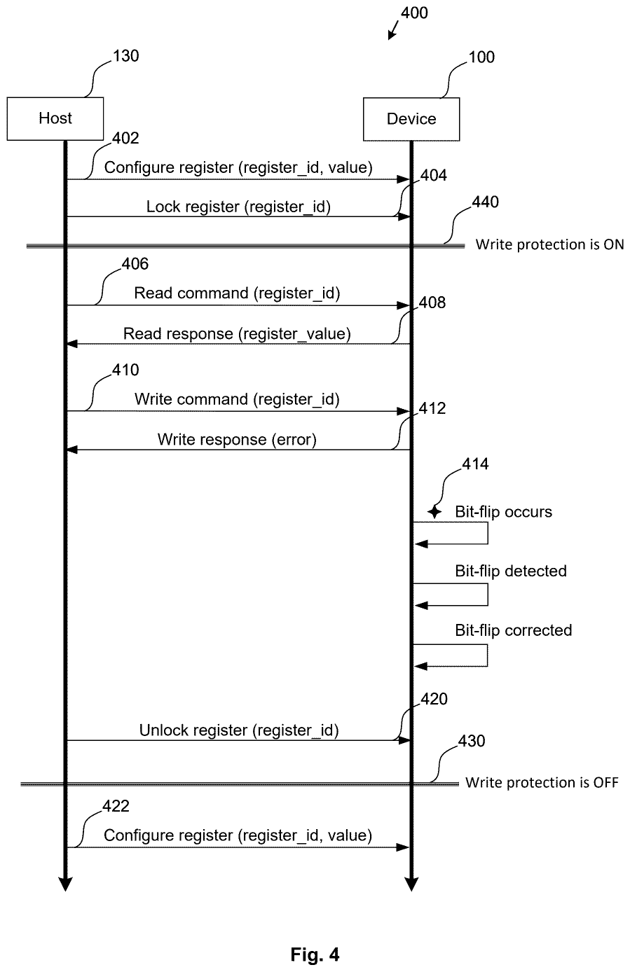

### FIG. 4—Message Sequence

FIG. 4 illustrates a message sequence 400 to set and clear write protection of a register of the device 100, in accordance with an embodiment. In the embodiment illustrated in FIG. 4, the device 100 is configured to receive commands from the host computer 130 to read from, and write to, registers 112 of the device. The messages illustrated in FIG. 4 are transmitted between the host computer and the device via data interface 150.

It will be appreciated by persons skilled in the art that numerous variations and/or modifications may be made to the message sequence of FIG. 4, without departing from the broad general scope of the present disclosure. For example, in some embodiments, the controller 110 of the device is configured to read from, and write to, registers 112 of the device. In such an embodiment, the message sequence may comprise signals communicated between the controller 110 and the register manager 160 of the device.

Message 402 comprises a command for the device 100 to configure a register, identifier by register_id, with a specified value. In response to receiving message 402, the device writes the specified value to the register. Lock message 404 comprises a command for the device to set write protection for the register identified by register_id. In response to receiving message 404, the device sets a write protection status bit associated with the register. Write protection is therefore set 440 for the register.

While write protection is set, the host computer may read from the register, as per read request message 406 and read response message 408. However, in response to the host computer issuing a write command 410, the device does not write to the register. Furthermore, the device issues a write error message 412 to the host computer.

In response to enabling write protection, the device also sets (e.g., enables) error protection for the register identified by register_id. Accordingly, in response to the occurrence of a bit-flip 414 of a bit of the register, the device is configured to detect the bit-flip and to correct the bit-flip.

The host computer may elect to disable write protection for the register identified by register_id, so that the host computer can reconfigure the register via write command 422. To disable write protection, the host computer sends an unlock message 420, which comprises a command for the device to clear (e.g., disable) write protection for the register identified by register_id. In response to receiving message 420, the device clears the write protection status bit associated with the register. Write protection is therefore disabled 450 for the register.

### Host Computer Management of Write Protection

In embodiments in which the data storage device is configured to receive write protection messages (e.g., to lock a hardware register) from the host computer, the host computer can control which of the hardware registers are write protected. Similarly, the host computer can control when to disable write protection of a hardware register (e.g., unlock a register), and therefore also disable error protection of the hardware register.

Typically, for the host computer to write a new value to a hardware register which is write protected, the host computer would first issue an unlock message which triggers the controller 110 to disable write protection for the register. The host computer may then re-enable write protection once the register is configured with the new value. If the host computer anticipates changing the value of a hardware register of the device 100 frequently, the host computer may elect to forgo write protection of that register in order to avoid the process of disabling and re-enabling write protection.

Advantageously, embodiments described herein provide the host computer with control over the application of write protection to, at least one, of the hardware registers 112.

### Error Protection Bits

The EP module is configured to determine and store one or more error protection (EP) bits 404 in association with a register. The EP module is configured to use the EP bits to determine whether a bit of the register has been flipped. In embodiments in which the EP module is configured to perform error correction as well as error detection, the EP module is configured to the use the EP bits to determine which one or more bits have flipped.

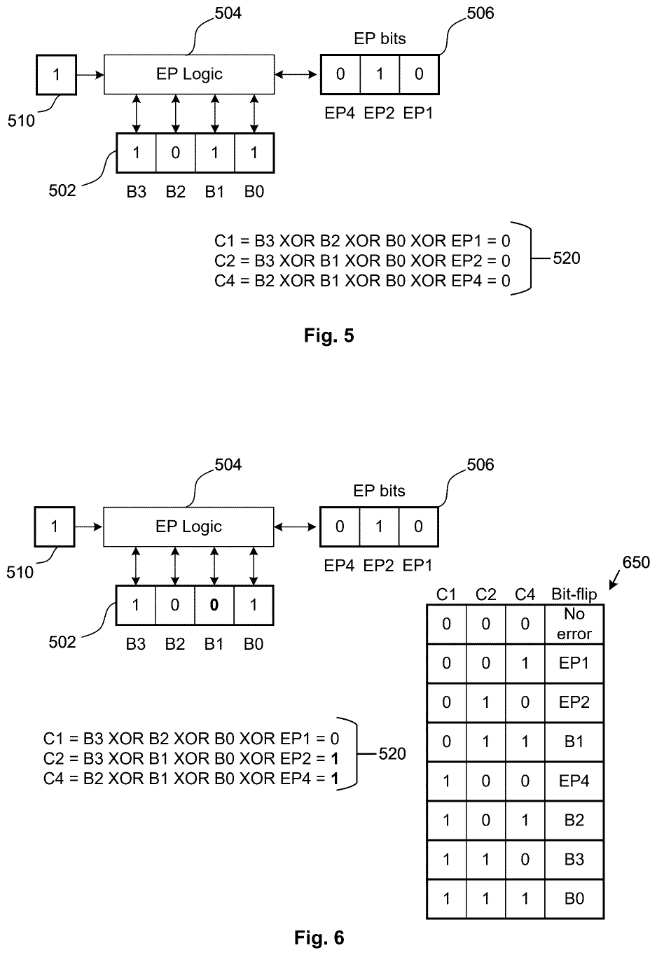

### FIGS. 5 & 6—Hamming Code Example

In some embodiments, the EP module may apply a Hamming code error protection algorithm. A Hamming code creates a set of parity bits that overlap so that a single-bit error in a data bit or a parity bit can be detected and corrected.

FIG. 5 illustrates the determination of EP bits for a register in accordance with a Hamming code, in accordance with an embodiment. FIG. 5 illustrates a 4-bit hardware register 502, logically connected to an EP module 504. The write protection bit 510 for register 502 is set. Accordingly, the EP module 504 is configured to perform error protection for the register.

The EP module is configured to perform error detection and correction in accordance with Hamming(7,4) Code. Hamming(7,4) is a linear error-correcting code that encodes four bits of data into seven bits by adding three parity bits. The parity bits are stored as error protection bits 506. Hamming(7,4) is a member of a larger family of Hamming codes. Hamming(7,4) can provide for the identification and correction of any single-bit error.

In response to the write protection bit 510 being set, the EP module calculates the EP bits 506, based on the bits stored in the register. The EP module sets each EP bit to a value such that the EP bits satisfy the three error checking equations C1, C2, and C4, collectively identified by reference numeral 520.

The error checking equations comprise parity equations. The EP bits are set such that the error checking equations calculate an even parity (e.g., evaluate to ‘0’). Accordingly, the EP4 bit is set to 0, to satisfy error checking equation C1, the EP2 bit is set to 1 to satisfy the error checking equation C2, and the EP1 bit is set to 0 to satisfy the error checking equation C1.

In some embodiments, the EP module may be configured to set the EP bits such that the error checking equations C1, C2 and C4 calculate an odd parity (e.g., evaluate to ‘1’).

FIG. 6 illustrates the detection of a bit-flip in the register of FIG. 5 in accordance with a Hamming Code, in accordance with an embodiment. Bit B1 of register 502 has flipped from a first value, being a ‘1’ (as illustrated in FIG. 5) to a second value, being a ‘0’. The EP module 504 is configured to calculate the value of error checking equations C1, C2 and C4 periodically. In some embodiments, this may mean evaluating the error checking equations each clock cycle.

As a result of evaluating the error checking equations, the EP module determines that both C2 and C4 now evaluate to ‘1’. In the absence of a bit-flip, each of the error checking equations evaluate to ‘0’. Accordingly, the evaluation of C2 and C4 as ‘1’ indicate that a bit-flip error has occurred, and the EP module has detected an error.

In an embodiment in which the EP module is also configured to perform error correction, the EP module can identify the flipped bit by considering which of the error checking equations evaluated as ‘1’. Table 650 illustrates the association between the values of error checking equations C1, C2 and C4 and the flipped bit. Table 650 may be encoded into the circuitry of the EP module. Notably, table 650 identifies any single bit-flip in the bits of register 502 or in the EP bits 506.

In response to identifying that bit B1 has flipped from its first value to a second value, the EP module writes the value ‘1’to bit B2 to revert the bit to its first value.

### Error Detection and Correction Algorithms

It will be appreciated by persons skilled in the art that numerous variations and/or modifications may be made to the above-described embodiment of the EP module, without departing from the broad general scope of the present disclosure. A plurality of error detection, or error detection and correction, algorithms, as described herein or as known by the person skilled in the art, may be applied to provide bit-flip protection to the registers of a digital device.

In some embodiments, the EP module comprises a single parity algorithm. The single parity algorithm is configured to determine a single parity bit for each protected hardware register. In such an embodiment, the EP bits comprise a single parity bit for each protected hardware register. The single parity bit is considered in conjunction with the bits of the protected register, to make the number of 1s in the register and the parity bit either even (if the EP module is configured to calculate even parity) or odd (if the EP module is configured to calculate odd parity). The single parity algorithm can detect single bit-flips but does not identify which bit of the protected register experienced the bit-flip. Therefore, the flipped bit cannot be corrected.

In some embodiments, the EP module comprises a two-dimensional parity algorithm, which extends the concept of parity bits to a two-dimensional array of bits, allowing detection of multiple errors in rows and columns of registers.

In some embodiments, the EP module comprises a Hamming code algorithm, which is configured to store multiple additional bits in association with the register data to enable the detection and correction of single-bit errors. FIGS. 5 and 6 illustrate an embodiment in which Hamming(7,4) code is applied; however, other embodiments, alternative Hamming codes may be applied.

A standard Hamming code can only detect and correct a single-bit error. If two bits are in error, it is possible that the two errors will look like a single-bit error. To account for that, an embodiment may include an additional overall parity bit to reliably detect errors in two bits. In some embodiments, the EP module comprises a single error correction/double error detection (SECDED) algorithm.

In some embodiments, the EP module comprises a Reed-Solomon code algorithm, which is configured to detect and correct multiple-bit errors. In some embodiments, the EP module comprises a Bose-Chaudhuri-Hocquenghem (BCH) Code algorithm, which comprises a cyclic error-correcting code that is configured to detect and correct multiple random errors. In some embodiments, the EP module comprises a Low-Density Parity-Check (LDPC) Code, which utilises a sparse matrix of parity-check equations to detect and correct errors. In some embodiments, the EP logic 165 comprises a Turbo Code, which combines two or more convolution codes with an interleaver to achieve near-optimal error correction performance.

In this specification, a statement that an element may be “at least one of” a list of options is to be understood to mean that the element may be any one of the listed options, or may be any combination of two or more of the listed options.

The use of “configured to” herein is meant as open and inclusive language that does not foreclose devices configured to perform additional tasks or steps. Additionally, the use of “based on” is meant to be open and inclusive, in that a process, step, calculation, or other action “based on” one or more recited conditions or values may, in practice, be based on additional conditions or values beyond those recited.

To avoid obscuring the inventive subject matter with unnecessary detail, various functional components (e.g., modules, devices, databases, etc.) that are not germane to conveying an understanding of the inventive subject matter have been omitted from FIG. 4. However, a skilled artisan will readily recognize that various additional functional components may be supported by the system 400 to facilitate additional functionality that is not specifically described herein. Furthermore, the various functional components depicted in FIG. 4 may reside on a single computing device or may be distributed across several computing devices in various arrangements such as those used in cloud-based architectures.

It will be appreciated by persons skilled in the art that numerous variations and/or modifications may be made to the above-described embodiments, without departing from the broad general scope of the present disclosure. Furthermore, it will be appreciated by persons skilled in the art that embodiments disclosed herein can be combined with one or more other embodiment disclosed herein, without departing from the broad general scope of the present disclosure. The present embodiments are, therefore, to be considered in all respects as illustrative and not restrictive.

It will be appreciated by persons skilled in the art that any suitable distribution of functionality between different functional units may be used without detracting from the invention. For example, functionality illustrated to be performed by separate computing devices may be performed by the same computing device. Likewise, functionality illustrated to be performed by a single computing device may be distributed amongst several computing devices. Hence, references to specific functional units are only to be seen as references to suitable means for providing the described functionality, rather than indicative of a strict logical or physical structure or organization.

It will be appreciated by persons skilled in the art that, for processes and methods disclosed herein, the operations performed in the processes and methods may be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

References herein to software or executable instructions are to be understood as referring to executable instructions stored in volatile or non-volatile memory. The memory can include any data storage device that can store data which can thereafter be read by a processor. Examples of memory include read-only memory (ROM), random-access memory (RAM), magnetic tape, optical data storage device, flash storage devices, or any other suitable storage devices.

Throughout this specification the word ‘comprise’, or variations such as ‘comprises’ or ‘comprising’, will be understood to imply the inclusion of a stated element, integer or step, or group of elements, integers or steps, but not the exclusion of any other element, integer or step, or group of elements, integers or steps.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Moreover, in the following claims, the terms “first,” “second,” and “third,” etc. are used merely as labels, and are not intended to impose numerical requirements on their objects.

1. A device comprising:
a volatile memory comprising a set of one or more hardware registers, the set of one or more hardware registers comprising a first register configured to store one or more bits including a first bit having a first value;
error protection circuitry configured to detect and correct at least one bit-flip in the first register; and
a controller configured to:
enable write protection for the first register; and
responsive to write protection being enabled for the first register, and responsive to detecting, by the error protection circuitry, the occurrence of a bit-flip of the first bit of the first register from the first value to a second value,
cause, by the error protection circuitry, the first bit of the first register to change from the second value to the first value.

2. The device of claim 1,
wherein the first register comprises a plurality of bits, each bit comprising a respective first value, and
wherein the error protection circuitry comprises a store of one or more error protection bits associated with the register, each error protection bit comprising a value calculated from the first value of each of the one or more bits of the first register.

3. The device of claim 2, wherein the controller is further configured to, for each error protection bit of the one or more error protection bits, determine the value of the error protection bit to satisfy a parity function.

4. The device of claim 2, wherein the respective values of the error protection bits are determined in accordance with one or more of: a Hamming code; a Single-bit Error Correction, Double-bit Error Detection (SECDED) code; Reed Solomon code; a Bose-Chaudhuri-Hocquenghem (BCH) code; and a Low-Density Parity-Check (LDPC) code.

5. The method of claim 2, wherein the controller is further configured to, responsive to detecting, by the error protection circuitry, the occurrence of a bit-flip of a first bit of the error protection bits from a first value of the error protection bit to a second value of the error correction bit,
cause, by the error protection circuitry, the first bit of the error protection bits to change from the second error protection bit value to the first error protection bit value.

6. The method of claim 2, wherein the controller is further configured to, responsive to write protection being enabled for the first register, apply, by the error protection circuitry, an error protection algorithm to the first register.

7. The device of claim 6, wherein the error protection algorithm comprises one or more of: a Hamming code; a Single-bit Error Correction, Double-bit Error Detection (SECDED) code; Reed Solomon code; a Bose-Chaudhuri-Hocquenghem (BCH) code; and a Low-Density Parity-Check (LDPC) code.

8. The method of claim 6, wherein applying the error protection algorithm comprises, in response to a trigger event, applying the error protection algorithm to:
the one or more bits of the first register; and
the one or more error protection bits.

9. The method of claim 8, wherein the trigger event comprises one or more of:
a clock edge;
a read of the first register;
a set period of time;
a set number of clock cycles; and
an error check signal.

10. The device of claim 1, wherein the controller is configured to enable write protection of the first register in response to receiving, from a controlling entity, an instruction to enable write protection of the register.

11. The device of claim 1, wherein enabling write protection for the first register comprises:
receiving, from a controlling entity, a write command to a write protection control register, the write command comprising a write protection control value; and
determining, based on the write protection control value, a subset of one or more registers of the set of one or more hardware registers,
wherein the subset of one or more registers comprises the first register.

12. The device of claim 11, wherein determining, based on the write protection control value, a subset of one or more registers of the set of one or more hardware registers comprises:
applying an operation to the write protection control value,
wherein the operation comprises one or more of: an arithmetic operation; a binary operation; a numerical operation; a logical shift operation; and an arithmetic shift operation.

13. The device of claim 1, wherein enabling write protection for the first register comprises:
receiving, from a controlling entity, a write command to a write protection activation register.

14. The device of claim 1, wherein the controller is further configured to:
responsive to write protection being enabled for the register, and responsive to receiving a write command for the first register, issue a write error signal.

15. The device of claim 14, wherein the controller is further configured to:
receive the write command, via a data interface, from a host computer, and transmit the write error signal, via the data interface, to the host computer.

16. The device of claim 1, wherein the controller is further configured to:
responsive to write protection being disabled for the register, and responsive to receiving a write command for the first register, the write command comprising a write value,
change the value of the bits of the first register to the write value.

17. The device of claim 1, wherein the controller is further configured to:
in response to detecting, by the error protection circuitry, the occurrence of a bit-flip of the bit of the register from the first value to a second value, issue an error signal.

18. The device of claim 1, further comprising:
a non-volatile memory configured to store data; and
a data path configured to provide data communication between a host computer system and at least part of the non-volatile memory, wherein at least one of the one or more hardware registers is configured to store an access parameter defining access by the host computer to the data configured to be stored in the non-volatile memory.

19. A method performed by a controller of a data storage device, the data storage device comprising:
a non-volatile memory configured to store data;
a data path configured to provide data communication between a host computer system and at least part of the non-volatile memory of the data storage device;
volatile memory comprising a set of one or more hardware registers, the set of one or more hardware registers comprising a first register configured to store one or more bits including a first bit having a first value;
error protection circuitry configured to detect and correct at least one bit-flip in the first register; and
the controller,
the method comprising:
enabling write protection for the first register; and
responsive to write protection being enabled for the first register, and responsive to detecting, by the error protection circuitry, the occurrence of a bit-flip of the first bit of the first register from the first value to a second value,
causing, by the error protection circuitry, the first bit of the first register to change from the second value to the first value.

20. A data storage device comprising:
a non-volatile memory configured to store data;
a data path configured to provide data communication between a host computer system and at least part of the non-volatile memory;
volatile memory comprising a set of one or more hardware registers, the set of one or more hardware registers comprising a first register configured to store one or more bits including a first bit having a first value;
means for enabling write protection for the first register; and
means for, responsive to write protection being enabled for the first register, and responsive to detecting the occurrence of a bit-flip of the first bit of the first register from a first value to a second value,
causing the first bit of the first register to change from the second value to the first value.
